(19) United States
(12) Patent Application Publication
(10) Pub. No.: US 2026/0089636 A1
(43) Pub. Date: Mar. 26, 2026

(54) TERMINAL, COMMUNICATION SYSTEM, AND TERMINAL SYNCHRONIZATION METHOD

(71) Applicant: SONY SEMICONDUCTOR SOLUTIONS CORPORATION, KANAGAWA (JP)

(72) Inventors: HIDEYA KITAYAMA, KANAGAWA (JP); KENTARO NAKAHARA, KANAGAWA (JP)

(21) Appl. No.: 19/109,639

(22) PCT Filed: Jul. 21, 2023
(86) PCT No.: PCT/JP2023/026739

§ 371 Date: Mar. 7, 2025

(30) Foreign Application Priority Data
Sep. 15, 2022 (JP) 2022-146663

(51) Int. Cl. H04W 52/02; H04W 8/24

(52) U.S. Cl. CPC H04W 52/0235; H04W 8/24

(57) ABSTRACT

To equalize power consumption of each terminal by grasping a power supply state of each terminal, and to achieve power saving of the entire system in a communication system including a plurality of terminals.

A power supply state determination information acquisition unit acquires power supply state determination information for determining the power supply state of a local terminal. A power supply state determination information communication unit performs communication for exchanging the power supply state determination information with another terminal. A representative terminal determination unit determines a representative terminal on the basis of the power supply state determination information of the local terminal and the another terminal. In a case where the local terminal corresponds to the representative terminal, a reference signal reception unit receives a reference signal necessary for synchronization and generates time information. A time information communication unit transmits the time information to the another terminal in a case where the local terminal corresponds to the representative terminal, and receives the time information from the representative terminal in a case where the local terminal does not correspond to the representative terminal.

### TECHNICAL FIELD

The present technology relates to a communication system. More specifically, the present technology relates to a terminal in a communication system and a terminal synchronization method.

### BACKGROUND ART

In a communication system including a plurality of terminals, there is known a technique for reducing power consumption by each terminal autonomously controlling start and pause. For example, a wireless communication system that controls a simple operation according to a remaining battery amount of a local station has been proposed (see, for example, Patent Document 1).

### CITATION LIST

### Patent Document

Patent Document 1: Japanese Patent Application Laid-Open No. 2013-030871

### SUMMARY OF THE INVENTION

### Problems to be Solved by the Invention

In the above-described conventional technique, each device controls the simple operation by its own determination, thereby reducing power consumption. However, in the control based on such an autonomous determination, there is a problem that total power consumption of the entire system cannot be considered, and a deviation in power consumption occurs between devices.

The present technology has been made in view of such a situation, and an object of the present technology is to equalize power consumption of each terminal by grasping a power supply state of each terminal, and to achieve power saving of the entire system in a communication system including a plurality of terminals.

### Solutions to Problems

The present technology has been made to solve the above-described problems, and a first aspect of the present technology is a terminal including: a power supply state determination information acquisition unit that acquires power supply state determination information for determining a power supply state of a local terminal, a power supply state determination information communication unit that performs communication for exchanging the power supply state determination information with another terminal, a representative terminal determination unit that determines a representative terminal on the basis of the power state determination information of the local terminal and the another terminal, a reference signal reception unit that receives a reference signal necessary for synchronization and generates time information in a case where the local terminal corresponds to the representative terminal, and a time information communication unit that transmits the time information to the another terminal in the case where the local terminal corresponds to the representative terminal, and receives the time information from the representative terminal in a case where the local terminal does not correspond to the representative terminal, a communication system, and a terminal synchronization method. This brings about an effect of suppressing the reception operation of the reference signal in terminals other than the representative terminal by transmitting the time information from the representative terminal that has received the reference signal to another terminal.

Furthermore, in the first aspect, the reference signal reception unit may receive a satellite signal as the reference signal and generate the time information in the case where the local terminal corresponds to the representative terminal. This brings about an effect of suppressing the reception operation of the satellite signal in the terminals other than the representative terminal.

Furthermore, in the first aspect, a sensor that acquires a sensing data signal, and a data signal transmission unit that transmits the sensing data signal after synchronization based on the time information is completed may be further included. This brings about an effect of transmitting the sensing data signal in a time-synchronized state.

Furthermore, in the first aspect, the power supply state determination information acquisition unit may acquire a value related to a power supply capacity obtained from a power supply of the local terminal as the power supply state determination information. In this case, the value related to the power supply capacity is a remaining power supply amount of the power supply of the local terminal. This brings about an effect of exchanging the value related to the power supply capacity between the terminals and determining the representative terminal.

Furthermore, in the first aspect, the power supply state determination information acquisition unit may acquire, as the power supply state determination information, a standby time required to receive the reference signal or the time information within a predetermined period. This brings about an effect of exchanging the standby time between the terminals and determining the representative terminal.

Furthermore, in the first aspect, the power supply state determination information acquisition unit may acquire, as the power supply state determination information, a value obtained by estimating a remaining amount of the power supply of the local terminal on the basis of a standby time required to receive the reference signal or the time information within a predetermined period. This brings about an effect of exchanging an estimated remaining power supply amount between the terminals and determining the representative terminal.

Furthermore, in the first aspect, a group terminal registration unit that registers identification information of the another terminal that forms a group may be further included, and the representative terminal determination unit may determine the representative terminal on the basis of the power supply state determination information of the local terminal and of the another terminal registered in the group terminal registration unit. This brings about an effect of determining the representative terminal between the terminals in the group.

### BRIEF DESCRIPTION OF DRAWINGS

FIG. 1 is a diagram illustrating an example of an overall configuration of a communication system according to an embodiment of the present technology.

FIG. 2 is a diagram illustrating an example of types of wireless communication by a terminal 100 according to the embodiment of the present technology.

FIG. 3 is a diagram illustrating a configuration example of the terminal 100 according to the first embodiment of the present technology.

FIG. 4 is a flowchart illustrating an example of an operation procedure of the terminal 100 according to the first embodiment of the present technology.

FIG. 5 is a sequence diagram illustrating an example of an operation of the communication system according to the first embodiment of the present technology.

FIG. 6 is a diagram illustrating a configuration example of a terminal 100 according to a second embodiment of the present technology.

FIG. 7 is a flowchart illustrating an example of an operation procedure of the terminal 100 according to the second embodiment of the present technology.

FIG. 8 is a sequence diagram illustrating an example of an operation of a communication system according to the second embodiment of the present technology.

FIG. 9 is a diagram illustrating a configuration example of a terminal 100 according to a third embodiment of the present technology.

FIG. 10 is a flowchart illustrating an example of an operation procedure of the terminal 100 according to the third embodiment of the present technology.

FIG. 11 is a sequence diagram illustrating an example of an operation of a communication system according to the third embodiment of the present technology.

### MODE FOR CARRYING OUT THE INVENTION

A mode for carrying out the present technology (hereinafter, referred to as an embodiment) is hereinafter described. The description will be given in the following order.
1. First Embodiment (an example of exchanging a remaining power supply amount measured from a power supply between terminals)
2. Second Embodiment (an example of exchanging a standby time of time information and estimating a remaining power supply amount in each terminal)
3. Third Embodiment (an example of estimating a remaining power supply amount from a standby time of time information and exchanging an estimated remaining power supply amount between terminals)
4. Modifications

### 1. First Embodiment

### Communication System

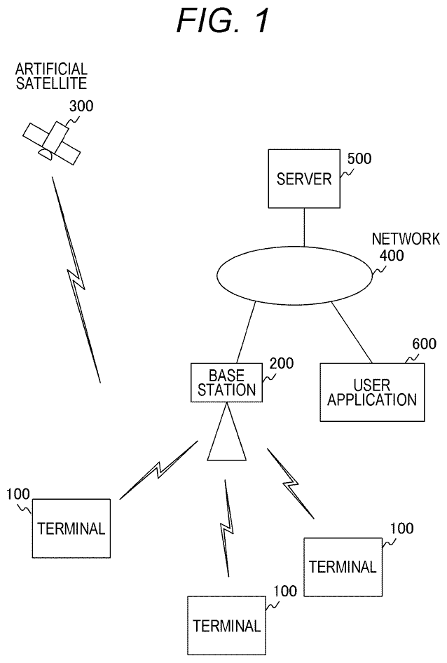

FIG. 1 is a diagram illustrating an example of an overall configuration of a communication system according to an embodiment of the present technology.

The communication system includes a plurality of terminals 100, a base station 200, a network 400, a server 500, and a user application 600.

The terminal 100 is a terminal constituting the communication system. The terminal 100 receives time information from an artificial satellite 300 or another terminal 100, and performs time synchronization on the basis of the time information. Therefore, the terminal 100 includes a communication unit between the artificial satellite 300 and the another terminal 100 as will be described below.

The network 400 is a network that connects the base station 200, the server 500, and the user application 600. The network 400 can be configured by, for example, the Internet.

The base station 200 is a wireless device that is connected to the network 400 and performs wireless communication with the plurality of terminals 100. The server 500 is connected to the network 400 and provides overall services for the plurality of terminals 100. The user application 600 is connected to the network 400 and provides an application executed in the plurality of terminals 100.

The artificial satellite 300 is a satellite constituting a global navigation satellite system (GNSS), and transmits a satellite signal to the terminal 100 and the like. The terminal 100 that has received the satellite signal on a ground can acquire its own position information and the time information on the basis of the satellite signal.

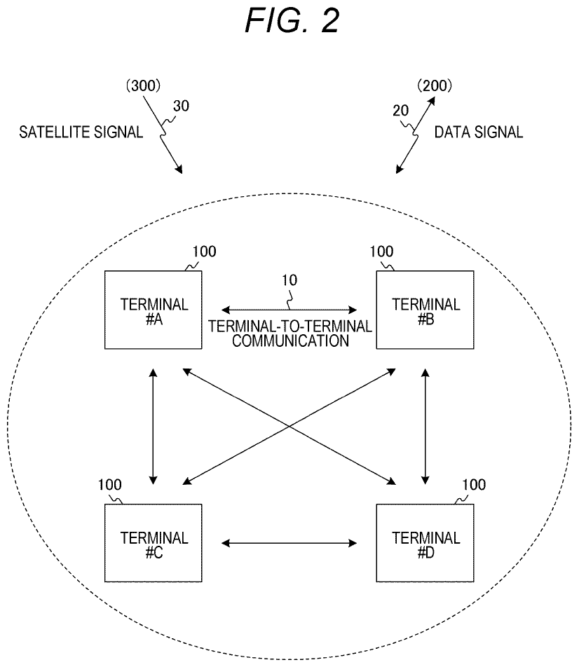

FIG. 2 is a diagram illustrating an example of types of wireless communication by the terminal 100 according to the embodiment of the present technology. It is assumed that each of the plurality of terminals 100 has the following three wireless communication functions.

Firstly, the terminal 100 has a wireless communication function for performing terminal-to-terminal communication 10 with another terminal. In the first embodiment of the present invention, the terminal 100 exchanges a remaining power supply amount with the another terminal. Furthermore, the time information is distributed from any one of the plurality of terminals 100 to the another terminal. The terminal-to-terminal communication 10 is used to implement communication between these terminals. Note that, in this example, four terminals #A to #D are illustrated as the plurality of terminals 100, but the number of terminals is not limited to four, and any number of terminals may be used.

Secondly, the terminal 100 has a wireless communication function with the base station 200. As will be described below, the terminal 100 includes, for example, a sensor, and transmits sensor information acquired by the sensor to the base station 200 as a data signal 20.

Thirdly, the terminal 100 has a wireless communication function for receiving a satellite signal 30 from the artificial satellite 300. The terminal 100 performs a positioning operation on the basis of the received satellite signal 30 to acquire the position information of its own terminal and the time information.

### Configuration of Terminal

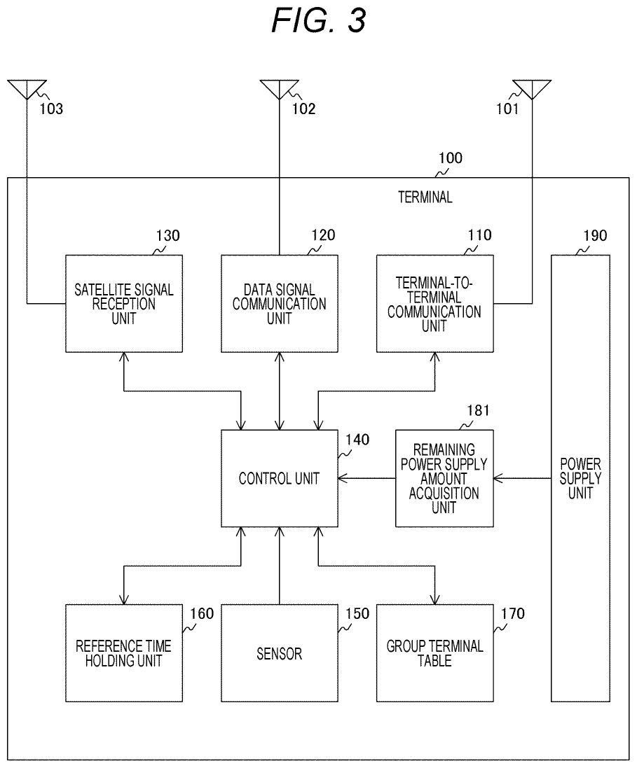

FIG. 3 is a diagram illustrating a configuration example of the terminal 100 according to the first embodiment of the present technology.

The terminal 100 in the first embodiment includes a terminal-to-terminal communication unit 110, a data signal communication unit 120, a satellite signal reception unit 130, a control unit 140, a sensor 150, a reference time holding unit 160, a group terminal table 170, a remaining power supply amount acquisition unit 181, and a power supply unit 190. Antennas 101 to 103 are connected to the terminal-to-terminal communication unit 110, the data signal communication unit 120, and the satellite signal reception unit 130, respectively.

The terminal-to-terminal communication 110 is a communication unit for performing the terminal-to-terminal communication 10 with another terminal. The terminal-to-terminal communication 10 by the terminal-to-terminal communication unit 110 can be implemented by, for example, device-to-device communication based on the Bluetooth standard (Bluetooth is a registered trademark). Note that the terminal-to-terminal communication unit 110 is an example of a power supply state determination information communication unit and a time information communication unit described in the claims.

The data signal communication unit 120 is a communication unit for communicating the data signal 20 with the base station 200. For the communication of the data signal 20 by the data signal communication unit 120, for example, communication in a wide range with low power consumption such as low power wide area (LPWA) is suitable.

The satellite signal reception unit 130 is a communication unit for receiving the satellite signal 30 from the artificial satellite 300. As the satellite signal 30 received by the satellite signal reception unit 130, for example, a satellite signal in a satellite system such as a global positioning system (GPS), GLONASS, or Galileo is assumed. Note that the satellite signal reception unit 130 is an example of a reference signal reception unit described in the claims.

The control unit 140 controls operation of each unit of the terminal 100. A specific operation of the terminal 100 will be described below. Note that the control unit 140 is an example of a representative terminal determination unit described in the claims.

The sensor 150 is for detecting information of a surrounding environment of the terminal 100. As the sensor 150, for example, a temperature sensor, a humidity sensor, a water level sensor, or the like is assumed. Taking a paddy field monitoring system as an application example, it is conceivable to provide a water level sensor for detecting a water level of a paddy field as the sensor 150 in each of the plurality of terminals 100.

The reference time holding unit 160 is a timer that holds reference time of the terminal 100. The terminal 100 performs the time synchronization by receiving the time information from the artificial satellite 300 or another terminal 100, and setting the reference time in the reference time holding unit 160 on the basis of the time information.

The group terminal table 170 is a table for registering the plurality of terminals 100 that forms a group that shares the time information. It is assumed that the plurality of terminals 100 constituting the communication system has completed grouping before performing a series of operations. Here, the grouping means an operation of registering the plurality of terminals 100 that forms a group in the group terminal table 170. Note that the group terminal table 170 is an example of a group terminal registration unit described in the claims.

The power supply unit 190 is a battery for supplying power to each unit of the terminal 100. The remaining power supply amount acquisition unit 181 acquires a remaining power supply amount available in the power supply unit 190 from the power supply unit 190. The remaining power supply amount acquired by the remaining power supply amount acquisition unit 181 is supplied to the control unit 140. Then, the remaining power supply amount is exchanged between the terminals constituting the group, and the remaining power supply amount is compared in each terminal. As a result, the terminal having the largest remaining power supply amount in the group is determined as the representative terminal. The representative terminal has a role of receiving the satellite signal 30 at the next timing and distributing the obtained time information to the other terminals. Note that the remaining power supply amount acquisition unit 181 is an example of a power supply state determination information acquisition unit described in the claims.

That is, the terminal having the largest remaining power supply amount among the terminals constituting the group receives, as a representative, the satellite signal 30 from the artificial satellite 300, and the terminal-to-terminal communication unit 110 distributes the time information to the other terminals. As a result, since only the representative terminal having a relatively large remaining power supply amount performs the reception operation of the satellite signal 30, the other terminals having a relatively small remaining power supply amount can suppress the power consumption accompanying the reception operation of the satellite signal 30, and the power consumption among the terminals in the group can be made uniform.

### Operation

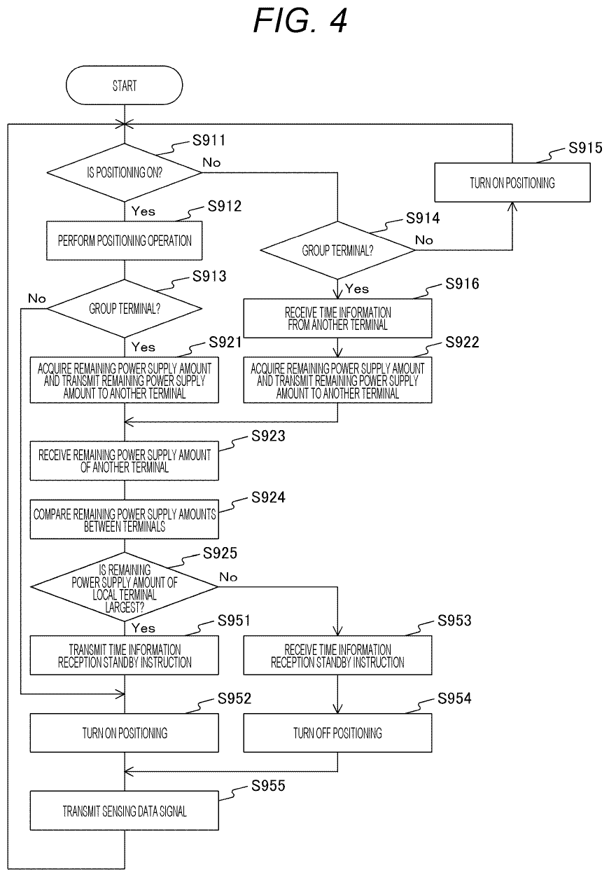

FIG. 4 is a flowchart illustrating an example of an operation procedure of the terminal 100 according to the first embodiment of the present technology.

In an initial state, setting of the positioning operation of the terminal 100 is on (step S911: Yes), the satellite signal reception unit 130 receives the satellite signal 30 from the artificial satellite 300 and performs the positioning operation (step S912). Thereby, the time information is acquired, and the time synchronization is performed.

At this time, if another terminal is registered in the group terminal table 170 (step S913: Yes), the remaining power supply amount acquisition unit 181 acquires its own remaining power supply amount, and the terminal-to-terminal communication unit 110 transmits the remaining power supply amount to the another terminal in the group (step S921).

Furthermore, the terminal-to-terminal communication unit 110 receives the remaining power supply amount of the another terminal in the group from each terminal (step S923). That is, the terminals in the group exchange the remaining power supply amounts with each other.

When receiving the remaining power supply amount from the another terminal, the terminal 100 compares the remaining power supply amounts (step S924). As a result, in a case of determining that its own remaining power supply amount is the largest (step S925: Yes), the terminal 100 itself serves as the representative terminal and transmits a reception standby instruction of the time information to the another terminal (step S951), and turns on the setting of the next positioning operation of the terminal itself (step S952). On the other hand, in a case of not determining that its own remaining power supply amount is the largest (step S925: No), the terminal 100 receives the reception standby instruction of the time information from the representative terminal (step S953), and turns off the setting of the next positioning operation of the terminal itself (step S954). As a result, the representative terminal that will receive the satellite signal 30 from the artificial satellite 300 next time is determined.

After the next positioning operation is set (step S952 or S954), the data signal communication unit 120 transmits a sensing data signal acquired by the sensor 150 to the base station 200 (step S955).

In a case where the setting of the positioning operation of the terminal 100 is off (step S911: No), if another terminal is registered in the group terminal table 170 (step S914: Yes), the terminal 100 receives the time information from the another terminal (representative terminal), and perform the time synchronization (step S916). Then, the remaining power supply amount acquisition unit 181 acquires its own remaining power supply amount, and the terminal-to-terminal communication unit 110 transmits the remaining power supply amount to the another terminal in the group (step S922). Thereafter, the processing in and after step S923 is performed.

Note that, in a case where the setting of the positioning operation of the terminal 100 is off (step S911: No), if another terminal is not registered in the group terminal table 170 (step S914: No), the terminal 100 cannot obtain the time information and thus turns on the setting of its own positioning operation (step S915).

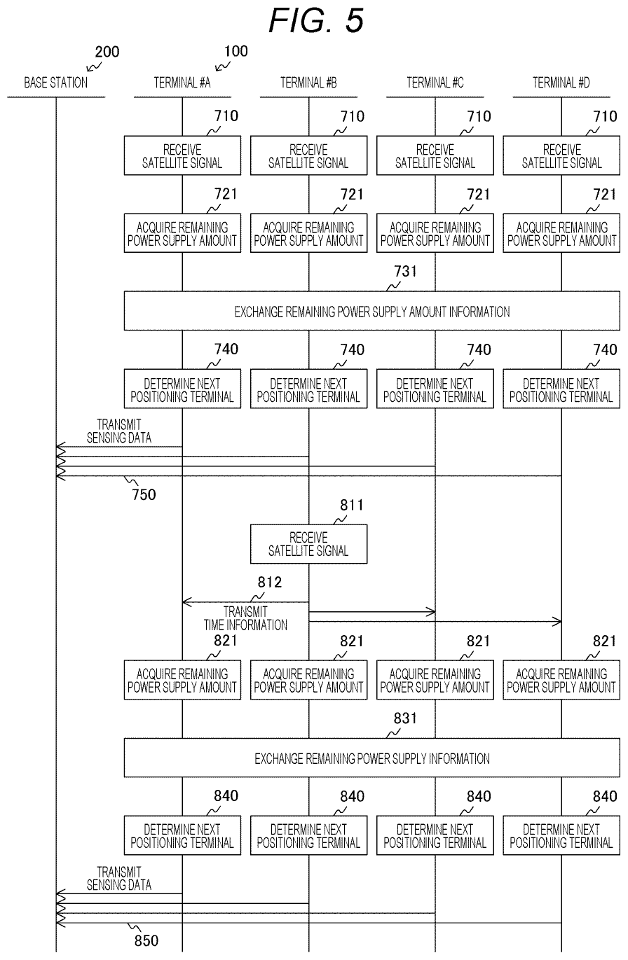

FIG. 5 is a sequence diagram illustrating an example of an operation of the communication system according to the first embodiment of the present technology. Note that, in this example, the four terminals #A to #D are illustrated as the plurality of terminals 100, but the number of terminals is not limited to four as described above. The same similarly applies to the following embodiments.

It is assumed that each of the terminals 100 operates independently in the initial state. Therefore, each of the terminals 100 independently performs the first positioning operation for time synchronization between the terminals 100. Therefore, all of the terminals #A to #D receive the satellite signal (710). Thereby, each of the terminals 100 acquires the time information and performs the time synchronization.

After the positioning operation is completed, the remaining power supply amount acquisition unit 181 of the terminal 100 acquires the remaining power supply amount (721). Then, the acquired remaining power supply amount is broadcast to the other terminals of the same group through the terminal-to-terminal communication unit 110 (731). Thereby, the terminals 100 of the group exchange mutual pieces of information regarding the remaining power supply amount.

When the exchange of the information regarding the remaining power supply amount is completed, each of the terminals 100 compares the remaining power supply amount of the local terminal with the remaining power supply amount of another terminal, and determines whether or not the representative terminal that will perform the next positioning operation is the local terminal (740).

Each of the terminals 100 transmits sensing data detected by the sensor 150 through the data signal communication unit 120 as a steady operation (750).

The second and subsequent positioning operations for time synchronization between the terminals 100 are executed on the basis of a result in 740 described above. In this example, assuming that the terminal #B is determined to perform the positioning operation as the representative terminal, the terminal #B performs a satellite signal reception operation (811) and broadcast-transmits the time information to the peripheral terminals (812). Meanwhile, the terminals #A, #C, and #D other than the terminal #B do not perform the satellite signal reception operation and wait for the time information from the terminal #B. As a result, each of the terminals 100 acquires the time information and performs the time synchronization.

After completion of the acquisition of the time information, the remaining power supply amount acquisition unit 181 of the terminal 100 acquires the remaining power supply amount (821). Then, the acquired remaining power supply amount is broadcast to the other terminals of the same group through the terminal-to-terminal communication unit 110 (831). Thereby, the terminals 100 of the group exchange mutual pieces of information regarding the remaining power supply amount.

When the exchange of the information regarding the remaining power supply amount is completed, each of the terminals 100 compares the remaining power supply amount of the local terminal with the remaining power supply amount of another terminal, and determines whether or not the representative terminal that will perform the next positioning operation is the local terminal (840).

Each of the terminals 100 transmits the sensing data detected by the sensor 150 through the data signal communication unit 120 as a steady operation (850). Thereafter, the representative terminal performs the positioning operation according to a determination result in 840, and the subsequent processing is repeated.

Note that, in a case where the time synchronization cannot be normally completed due to deterioration of a communication state or the like, it is also assumed that the time synchronization is terminated due to timeout. In this case, the processing is continued without waiting for the time synchronization.

As described above, in the first embodiment of the present technology, the remaining power supply amounts acquired by the remaining power supply amount acquisition unit 181 are mutually compared between the terminals 100, and only the representative terminal having a relatively large remaining power supply amount performs the reception operation of the satellite signal 30. As a result, the other terminals having a relatively small remaining power supply amount can suppress the power consumption associated with the reception operation of the satellite signal 30, and the power consumption amount among the terminals in the group can be made uniform.

### 2. Second Embodiment

In the above-described first embodiment, the remaining power supply amount is acquired from the power supply unit 190, and the representative terminal is determined on the basis of the remaining power supply amount. In this case, the accuracy of the remaining power supply amount obtained from the power supply unit 190 may not be high, and the representative terminal may not be appropriately determined. Therefore, in the second embodiment, a representative terminal is determined using a standby time required to receive a satellite signal or a time signal. Note that an overall configuration of a communication system is similar to that of the above-described first embodiment, and thus detailed description thereof is omitted.

### Configuration of Terminal

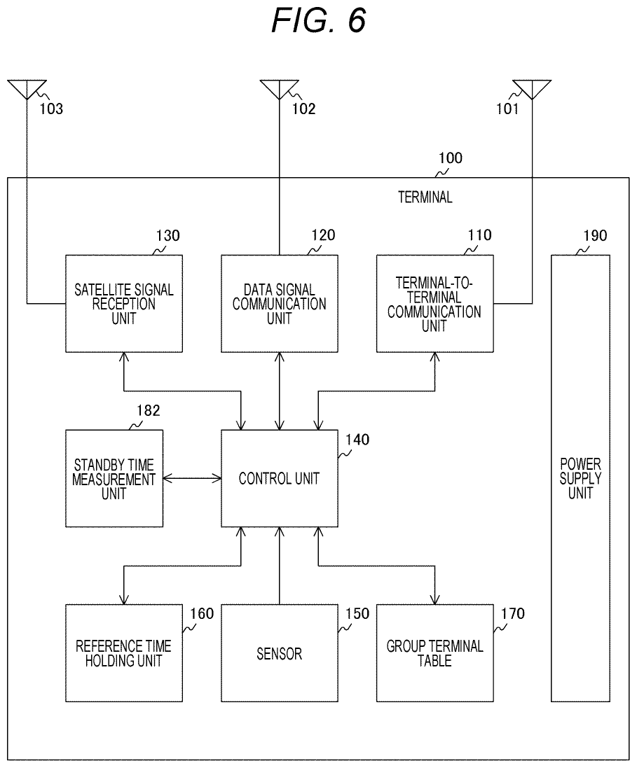

FIG. 6 is a diagram illustrating a configuration example of a terminal 100 according to the second embodiment of the present technology.

The terminal 100 in the second embodiment includes a standby time measurement unit 182 instead of the remaining power supply amount acquisition unit 181 in the first embodiment. Other points are similar to those of the above-described first embodiment, and thus detailed description thereof is omitted.

The standby time measurement unit 182 measures the standby time required to acquire the time information. That is, in a case of the representative terminal, the standby time measurement unit 182 measures, as the standby time, a time from start of a reception operation of the satellite signal to acquisition of time information through signal processing. Furthermore, in a case of a terminal other than the representative terminal, a time from start of standby for the time information from the representative terminal to acquisition of the time information is measured as the standby time. Note that the standby time measurement unit 182 is an example of a power supply state determination information acquisition unit described in the claims.

The measured standby time is distributed to other terminals through a terminal-to-terminal communication unit 110. As a result, the terminals 100 compare mutual standby times. It is estimated that a remaining power supply amount of a power supply unit 190 decreases as the standby time is longer. Therefore, by comparing the standby times between the terminals 100, a terminal with a small decrease in the remaining power supply amount is determined as the representative terminal.

### Operation

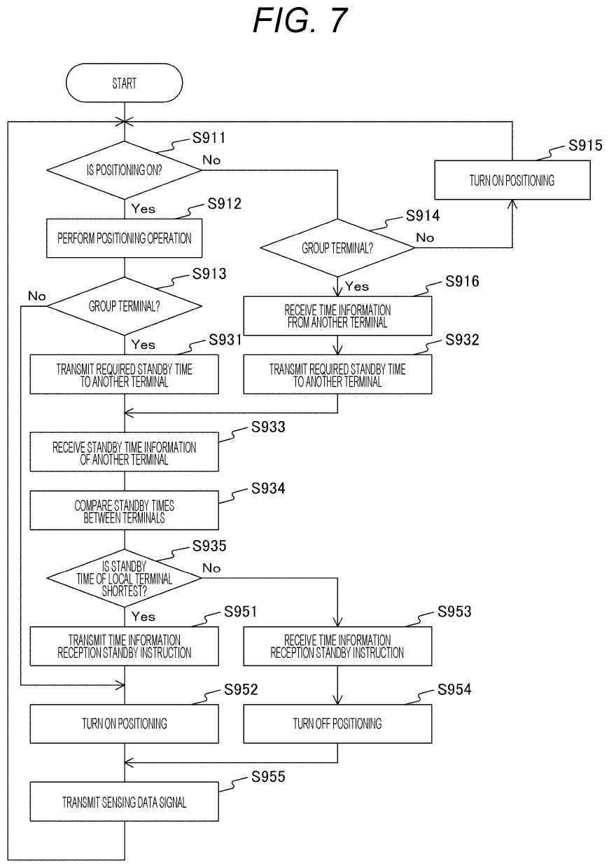

FIG. 7 is a flowchart illustrating an example of an operation procedure of the terminal 100 according to the second embodiment of the present technology.

Since a processing procedure of steps S911 to S916 is similar to that of the above-described first embodiment, detailed description thereof is omitted.

If another terminal is registered in a group terminal table 170 (step S913: Yes), the terminal that has received the satellite signal measures the standby time required to receive the satellite signal and acquire the time information using the standby time measurement unit 182, and the terminal-to-terminal communication unit 110 transmits the standby time to the another terminal (step S931). Furthermore, the terminal that has not received the satellite signal receives the time information from the another terminal (step S916), and measures the standby time required to acquire the time information using the standby time measurement unit 182, and the terminal-to-terminal communication unit 110 transmits its own standby time to the another terminal (step S932).

Furthermore, the terminal-to-terminal communication unit 110 receives the standby time of the another terminal in the group from each terminal (step S933). That is, the terminals in the group exchange the standby times with each other.

When receiving the standby time from the another terminal, the terminal 100 compares the standby times (step S934). As a result, in a case of determining that its own standby time is the shortest (step S935: Yes), the terminal 100 itself serves as the representative terminal and transmits a reception standby instruction of the time information to the another terminal (step S951), and turns on setting of a next positioning operation of the terminal itself (step S952). On the other hand, in a case of not determining that its own standby time is the shortest (step S935: No), the terminal 100 receives the reception standby instruction of the time information from the representative terminal (step S953), and turns off the setting of the next positioning operation of the terminal itself (step S954). As a result, the representative terminal that will receive the satellite signal 30 from the artificial satellite 300 next time is determined.

Since subsequent processing is similar to that of the above-described first embodiment, detailed description thereof is omitted.

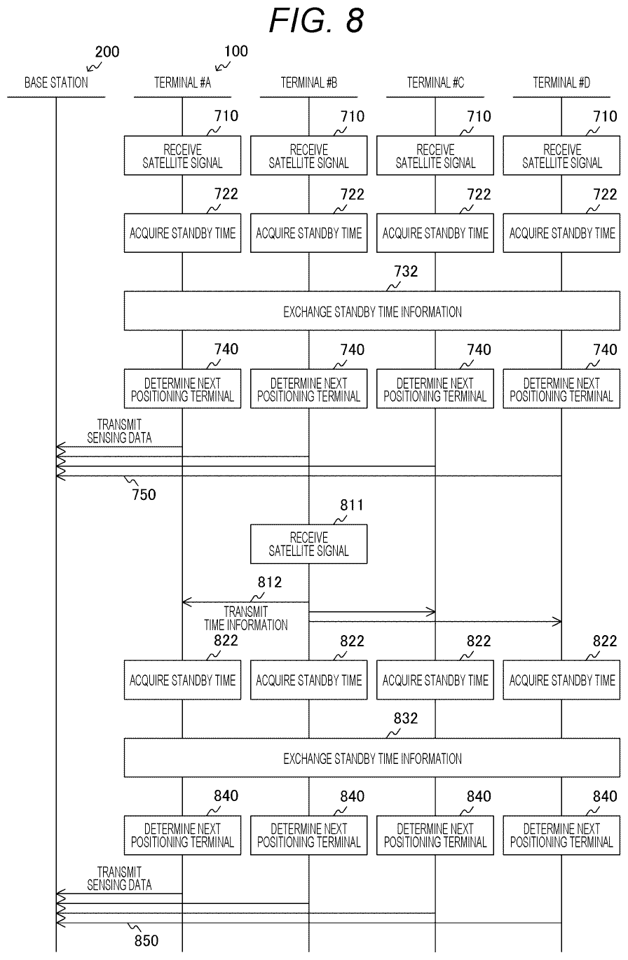

FIG. 8 is a sequence diagram illustrating an example of an operation of a communication system according to the second embodiment of the present technology.

It is assumed that each of the terminals 100 operates independently in an initial state, similarly to the above-described first embodiment. Therefore, each of the terminals 100 independently performs the first positioning operation for time synchronization between the terminals 100. Therefore, all of the terminals #A to #D receive the satellite signal (710). Thereby, each of the terminals 100 acquires the time information and performs the time synchronization.

Meanwhile, the standby time measurement unit 182 of the terminal 100 measures the standby time required to receive the satellite signal and acquire the time information (722). Then, the measured standby time is broadcast to the other terminals of the same group through the terminal-to-terminal communication unit 110 (732). Thereby, the terminals 100 of the group exchange mutual pieces of information regarding the standby time.

When the exchange of the information regarding the standby time is completed, each of the terminals 100 compares the standby time of the local terminal with the standby time of another terminal, and determines whether or not the representative terminal that will perform the next positioning operation is the local terminal (740).

Each of the terminals 100 transmits sensing data detected by the sensor 150 through the data signal communication unit 120 as a steady operation (750).

The second and subsequent positioning operations for time synchronization between the terminals 100 are executed on the basis of a result in 740 described above. In this example, assuming that the terminal #B is determined to perform the positioning operation as the representative terminal, the terminal #B performs a satellite signal reception operation (811) and broadcast-transmits the time information to the peripheral terminals (812). Meanwhile, the terminals #A, #C, and #D other than the terminal #B do not perform the satellite signal reception operation and wait for the time information from the terminal #B. As a result, each of the terminals 100 acquires the time information and performs the time synchronization.

Meanwhile, the standby time measurement unit 182 of the terminal 100 measures the standby time (822). Then, the measured standby time is broadcast to the other terminals of the same group through the terminal-to-terminal communication unit 110 (832). Thereby, the terminals 100 of the group exchange mutual pieces of information regarding the standby time.

When the exchange of the information regarding the standby time is completed, each of the terminals 100 compares the standby time of the local terminal with the standby time of another terminal, and determines whether or not the representative terminal that will perform the next positioning operation is the local terminal (840).

Each of the terminals 100 transmits the sensing data detected by the sensor 150 through the data signal communication unit 120 as a steady operation (850). Thereafter, the representative terminal performs the positioning operation according to a determination result in 840, and the subsequent processing is repeated.

As described above, in the second embodiment of the present technology, the standby times measured by the standby time measurement unit 182 are compared between the terminals 100, and only the representative terminal having the shortest standby time performs the reception operation of the satellite signal 30. As a result, the other terminals previously having had a long standby time can suppress power consumption associated with the reception operation of the satellite signal 30, and the power consumption amount among the terminals in the group can be made uniform.

### 3. Third Embodiment

In the above-described second embodiment, the representative terminal is determined by exchanging the standby time in each terminal between the terminals and comparing the standby times. In contrast, in a third embodiment, a representative terminal is determined by exchanging a remaining power supply amount estimated from a standby time between terminals and comparing the estimated remaining power supply amounts. Note that an overall configuration of a communication system is similar to that of the above-described first embodiment, and thus detailed description thereof is omitted.

### Configuration of Terminal

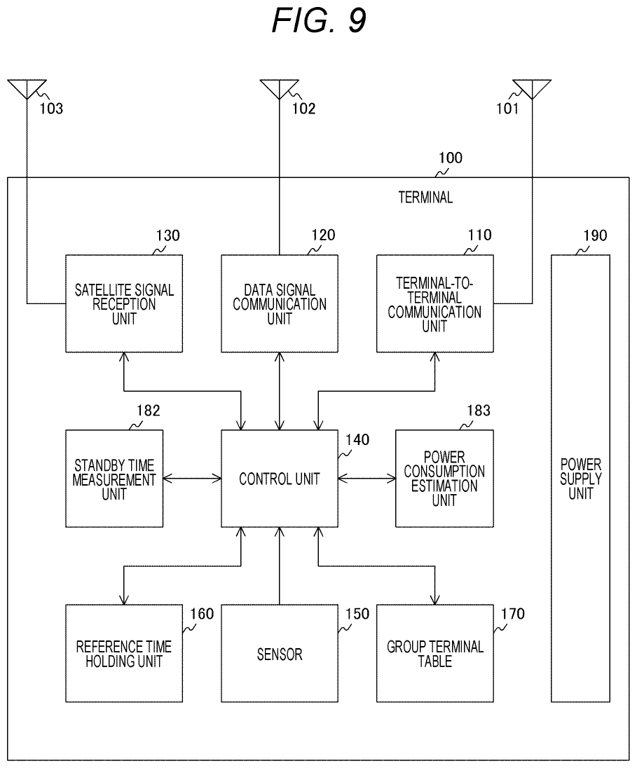

FIG. 9 is a diagram illustrating a configuration example of a terminal 100 according to the third embodiment of the present technology.

The terminal 100 in the third embodiment includes a power consumption estimation unit 183 in addition to the configuration of the second embodiment. Other points are similar to those of the above-described second embodiment, and thus detailed description thereof is omitted.

The power consumption estimation unit 183 estimates a power consumption amount on the basis of a standby time required to acquire time information. The standby time is measured by the standby time measurement unit 182 similarly to the above-described second embodiment. In the third embodiment, the standby time is not exchanged as it is between the terminals, but the remaining power supply amount obtained from the power consumption amount estimated by the power consumption estimation unit 183 on the basis of the standby time is exchanged between the terminals. Thereby, only the representative terminal having a relatively large remaining power supply amount performs a reception operation of a satellite signal 30, so that the other terminals having a relatively small remaining power supply amount can suppress the power consumption accompanying the reception operation of the satellite signal 30, similarly to the above-described first embodiment. Note that the power consumption estimation unit 183 is an example of a power supply state determination information acquisition unit described in the claims.

### Operation

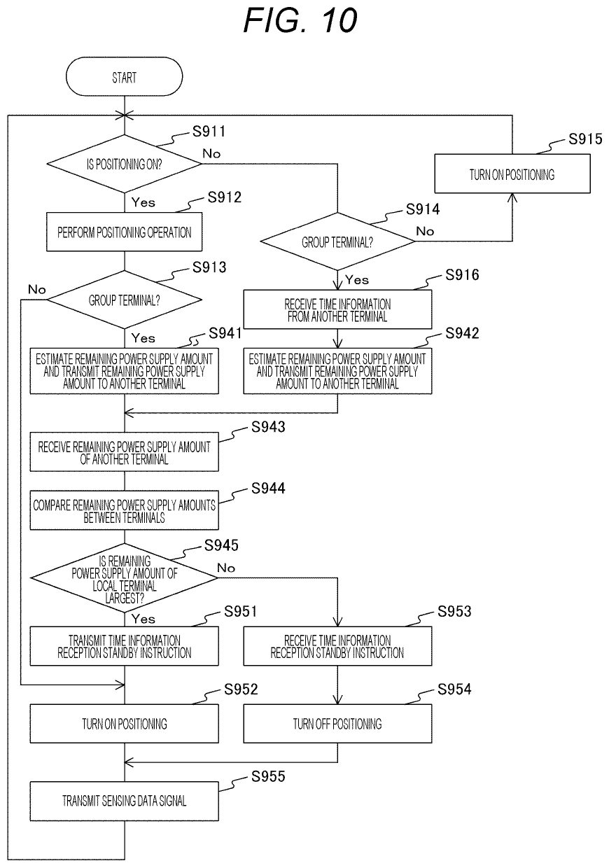

FIG. 10 is a flowchart illustrating an example of an operation procedure of the terminal 100 according to the third embodiment of the present technology.

Since a processing procedure of steps S911 to S916 is similar to that of the above-described first embodiment, detailed description thereof is omitted.

If another terminal is registered in a group terminal table 170 (step S913: Yes), the terminal that has received the satellite signal measures the standby time required to receive the satellite signal and acquire the time information using the standby time measurement unit 182. Then, the power consumption estimation unit 183 estimates the power consumption amount on the basis of the standby time and acquires the remaining power supply amount. The remaining power supply amount is transmitted to another terminal through a terminal-to-terminal communication unit 110 (step S941). Furthermore, the terminal that has not received the satellite signal receives the time information from the another terminal (step S916), measures the standby time required to acquire the time information using the standby time measurement unit 182, estimates the power consumption amount using the power consumption estimation unit 183, acquires the remaining power supply amount, and transmits the remaining power supply amount to the another terminal through the terminal-to-terminal communication unit 110 (step S942).

Furthermore, the terminal-to-terminal communication unit 110 receives the remaining power supply amount of the another terminal in the group from each terminal (step S943). That is, the terminals in the group exchange the remaining power supply amounts with each other.

When receiving the remaining power supply amount from the another terminal, the terminal 100 compares the remaining power supply amounts (step S944). As a result, in a case of determining that its own remaining power supply amount is the largest (step S945: Yes), the terminal 100 itself serves as the representative terminal and transmits a reception standby instruction of the time information to the another terminal (step S951), and turns on the setting of the next positioning operation of the terminal itself (step S952). On the other hand, in a case of not determining that its own remaining power supply amount is the largest (step S945: No), the terminal 100 receives the reception standby instruction of the time information from the representative terminal (step S953), and turns off the setting of the next positioning operation of the terminal itself (step S954). As a result, the representative terminal that will receive the satellite signal 30 from the artificial satellite 300 next time is determined.

Since subsequent processing is similar to that of the above-described first embodiment, detailed description thereof is omitted.

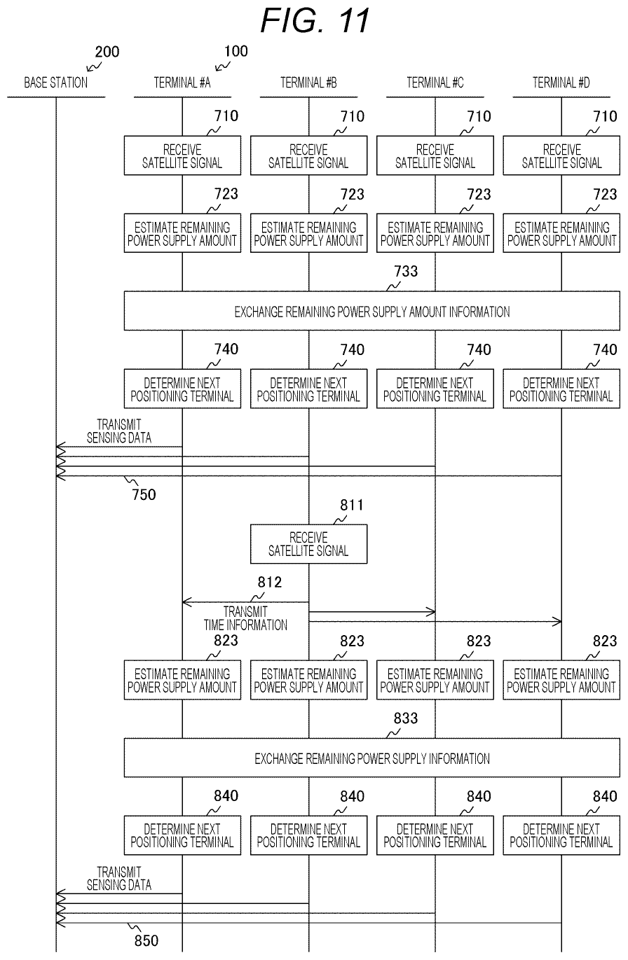

FIG. 11 is a sequence diagram illustrating an example of an operation of the communication system according to the third embodiment of the present technology.

It is assumed that each of the terminals 100 operates independently in an initial state, similarly to the above-described first embodiment. Therefore, each of the terminals 100 independently performs the first positioning operation for time synchronization between the terminals 100. Therefore, all of the terminals #A to #D receive the satellite signal (710). Thereby, each of the terminals 100 acquires the time information and performs the time synchronization.

Meanwhile, the standby time measurement unit 182 of the terminal 100 measures the standby time required to receive the satellite signal and acquire the time information, and the power consumption estimation unit 183 estimates the power consumption amount on the basis of the standby time to acquire the remaining power supply amount (723). Then, the estimated remaining power supply amount is broadcast to the other terminals of the same group through the terminal-to-terminal communication unit 110 (733). Thereby, the terminals 100 of the group exchange mutual pieces of information regarding the remaining power supply amount.

When the exchange of the information regarding the remaining power supply amount is completed, each of the terminals 100 compares the remaining power supply amount of the local terminal with the remaining power supply amount of another terminal, and determines whether or not the representative terminal that will perform the next positioning operation is the local terminal (740).

Each of the terminals 100 transmits sensing data detected by the sensor 150 through the data signal communication unit 120 as a steady operation (750).

The second and subsequent positioning operations for time synchronization between the terminals 100 are executed on the basis of a result in 740 described above. In this example, assuming that the terminal #B is determined to perform the positioning operation as the representative terminal, the terminal #B performs a satellite signal reception operation (811) and broadcast-transmits the time information to the peripheral terminals (812). Meanwhile, the terminals #A, #C, and #D other than the terminal #B do not perform the satellite signal reception operation and wait for the time information from the terminal #B. As a result, each of the terminals 100 acquires the time information and performs the time synchronization.

Meanwhile, the standby time measurement unit 182 of the terminal 100 measures the standby time, and the power consumption estimation unit 183 estimates the power consumption amount on the basis of the standby time to acquire the remaining power supply amount (823). Then, the estimated remaining power supply amount is broadcast to the other terminals of the same group through the terminal-to-terminal communication unit 110 (833). Thereby, the terminals 100 of the group exchange mutual pieces of information regarding the remaining power supply amount.

When the exchange of the information regarding the remaining power supply amount is completed, each of the terminals 100 compares the remaining power supply amount of the local terminal with the remaining power supply amount of another terminal, and determines whether or not the representative terminal that will perform the next positioning operation is the local terminal (840).

Each of the terminals 100 transmits the sensing data detected by the sensor 150 through the data signal communication unit 120 as a steady operation (850). Thereafter, the representative terminal performs the positioning operation according to a determination result in 840, and the subsequent processing is repeated.

As described above, in the third embodiment of the present technology, the remaining power supply amounts estimated by the power consumption estimation unit 183 are compared between the terminals 100, and only the representative terminal having the largest remaining power supply amount performs the reception operation of the satellite signal 30. As a result, the other terminals having a small remaining power supply amount can suppress the power consumption associated with the reception operation of the satellite signal 30, and the power consumption amount among the terminals in the group can be made uniform.

### 4. Modifications

In the above-described embodiments, the representative terminal receives the satellite signal and distributes the obtained time information to the other terminal, but the present invention is not limited to the distribution of the time information. For example, the terminal may not have a communication function for a satellite signal. Furthermore, a system capable of performing asynchronous communication between the terminal and the base station may be used.

Furthermore, the transmission of the sensing data from the terminal to the base station and the communication of the information exchange between the terminals may not be performed separately, and the same communication method may be used.

In the above-described embodiments, LPWA is exemplified as the communication method between the terminal and the base station, but the present invention is not limited thereto, and can be applied to all of wireless communication systems such as mobile phones and wireless local area networks (WLANs).

Note that the embodiments described above show examples for embodying the present technology, and the matters in the embodiments and the matters specifying the invention in the claims have correspondence relationships. Similarly, the matters specifying the invention in the claims and matters with the same names in the embodiments of the present technology have correspondence relationships. However, the present technology is not limited to the embodiments, and can be embodied by applying various modifications to the embodiments without departing from the scope of the present technology.

Furthermore, the procedures described in the above-described embodiment may be considered as a method including a series of procedures and may be considered as a program for allowing a computer to execute the series of procedures and a recording medium which stores the program. As this recording medium, for example, a compact disc (CD), a MiniDisc (MD), a digital versatile disc (DVD), a memory card, a Blu-ray (registered trademark) disc, and the like can be used.

Note that advantageous effects described in the present description are merely examples and are not limited, and other advantageous effects may be provided.

Note that the present technology may also have the following configurations.

(1) A terminal including:
a power supply state determination information acquisition unit that acquires power supply state determination information for determining a power supply state of a local terminal;
a power supply state determination information communication unit that performs communication for exchanging the power supply state determination information with another terminal;
a representative terminal determination unit that determines a representative terminal on a basis of the power state determination information of the local terminal and the another terminal;
a reference signal reception unit that receives a reference signal necessary for synchronization and generates time information in a case where the local terminal corresponds to the representative terminal; and
a time information communication unit that transmits the time information to the another terminal in the case where the local terminal corresponds to the representative terminal, and receives the time information from the representative terminal in a case where the local terminal does not correspond to the representative terminal.

(2) The terminal according to (1), in which
the reference signal reception unit receives a satellite signal as the reference signal and generates the time information in the case where the local terminal corresponds to the representative terminal.

(3) The terminal according to (1) or (2), further including:
a sensor that acquires a sensing data signal; and
a data signal transmission unit that transmits the sensing data signal after synchronization based on the time information is completed.

(4) The terminal according to any one of (1) to (3), in which
the power supply state determination information acquisition unit acquires a value related to a power supply capacity obtained from a power supply of the local terminal as the power supply state determination information.

(5) The terminal according to (4), in which
the value related to the power supply capacity includes a remaining power supply amount of the power supply of the local terminal.

(6) The terminal according to any one of (1) to (3), in which
the power supply state determination information acquisition unit acquires, as the power supply state determination information, a standby time required to receive the reference signal or the time information within a predetermined period.

(7) The terminal according to any one of (1) to (3), in which
the power supply state determination information acquisition unit acquires, as the power supply state determination information, a value obtained by estimating a remaining amount of the power supply of the local terminal on a basis of a standby time required to receive the reference signal or the time information within a predetermined period.

(8) The terminal according to any one of (1) to (7), further including:
a group terminal registration unit that registers identification information of the another terminal that forms a group, in which
a representative terminal determination unit determines the representative terminal on the basis of the power supply state determination information of the local terminal and of the another terminal registered in the group terminal registration unit.

(9) A communication system including:
a base station; and a plurality of terminals, in which
the terminal includes
a sensor that acquires a sensing data signal;
a power supply state determination information acquisition unit that acquires power supply state determination information for determining a power supply state of a local terminal;
a power supply state determination information communication unit that performs communication for exchanging the power supply state determination information with another terminal;
a representative terminal determination unit that determines a representative terminal on a basis of the power state determination information of the local terminal and the another terminal;
a reference signal reception unit that receives a reference signal necessary for synchronization and generates time information in a case where the local terminal corresponds to the representative terminal;
a time information communication unit that transmits the time information to the another terminal in the case where the local terminal corresponds to the representative terminal, and receives the time information from the representative terminal in a case where the local terminal does not correspond to the representative terminal; and
a data signal transmission unit that transmits the sensing data signal to the base station after synchronization based on the time information is completed.

(10) A terminal synchronization method including:
by a power supply state determination information acquisition unit, acquiring power supply state determination information for determining a power supply state of a local terminal;
by a power supply state determination information communication unit, performing communication for exchanging the power supply state determination information with another terminal;
by a representative terminal determination unit, determining a representative terminal on a basis of the power state determination information of the local terminal and the another terminal;
by a reference signal reception unit, receiving a reference signal necessary for synchronization and generating time information in a case where the local terminal corresponds to the representative terminal; and
by a time information communication unit, transmitting the time information to the another terminal in the case where the local terminal corresponds to the representative terminal, and receiving the time information from the representative terminal in a case where the local terminal does not correspond to the representative terminal.

### REFERENCE SIGNS LIST

10 Terminal-to-terminal communication
20 Data signal
30 Satellite signal
100 Terminal
101 to 103 Antenna
110 Terminal-to-terminal communication unit
120 Data signal communication unit
130 Satellite signal reception unit
140 Control unit
150 Sensor
160 Reference time holding unit
170 Group terminal table
181 Remaining power supply amount acquisition unit
182 Standby time measurement unit
183 Power consumption estimation unit
190 Power supply unit
200 Base station
300 Artificial satellite
400 Network
500 Server
600 User application

1. A terminal comprising:
a power supply state determination information acquisition unit that acquires power supply state determination information for determining a power supply state of a local terminal;
a power supply state determination information communication unit that performs communication for exchanging the power supply state determination information with another terminal;
a representative terminal determination unit that determines a representative terminal on a basis of the power state determination information of the local terminal and the another terminal;
a reference signal reception unit that receives a reference signal necessary for synchronization and generates time information in a case where the local terminal corresponds to the representative terminal; and
a time information communication unit that transmits the time information to the another terminal in the case where the local terminal corresponds to the representative terminal, and receives the time information from the representative terminal in a case where the local terminal does not correspond to the representative terminal.

2. The terminal according to claim 1, wherein
the reference signal reception unit receives a satellite signal as the reference signal and generates the time information in the case where the local terminal corresponds to the representative terminal.

3. The terminal according to claim 1, further comprising:
a sensor that acquires a sensing data signal; and
a data signal transmission unit that transmits the sensing data signal after synchronization based on the time information is completed.

4. The terminal according to claim 1, wherein
the power supply state determination information acquisition unit acquires a value related to a power supply capacity obtained from a power supply of the local terminal as the power supply state determination information.

5. The terminal according to claim 4, wherein
the value related to the power supply capacity includes a remaining power supply amount of the power supply of the local terminal.

6. The terminal according to claim 1, wherein
the power supply state determination information acquisition unit acquires, as the power supply state determination information, a standby time required to receive the reference signal or the time information within a predetermined period.

7. The terminal according to claim 1, wherein
the power supply state determination information acquisition unit acquires, as the power supply state determination information, a value obtained by estimating a remaining amount of the power supply of the local terminal on a basis of a standby time required to receive the reference signal or the time information within a predetermined period.

8. The terminal according to claim 1, further comprising:
a group terminal registration unit that registers identification information of the another terminal that forms a group, wherein
a representative terminal determination unit determines the representative terminal on a basis of the power supply state determination information of the local terminal and of the another terminal registered in the group terminal registration unit.

9. A communication system comprising:
a base station; and a plurality of terminals, wherein
the terminal includes
a sensor that acquires a sensing data signal;
a power supply state determination information acquisition unit that acquires power supply state determination information for determining a power supply state of a local terminal;
a power supply state determination information communication unit that performs communication for exchanging the power supply state determination information with another terminal;
a representative terminal determination unit that determines a representative terminal on a basis of the power state determination information of the local terminal and the another terminal;
a reference signal reception unit that receives a reference signal necessary for synchronization and generates time information in a case where the local terminal corresponds to the representative terminal;
a time information communication unit that transmits the time information to the another terminal in the case where the local terminal corresponds to the representative terminal, and receives the time information from the representative terminal in a case where the local terminal does not correspond to the representative terminal; and
a data signal transmission unit that transmits the sensing data signal to the base station after synchronization based on the time information is completed.

10. A terminal synchronization method comprising:
by a power supply state determination information acquisition unit, acquiring power supply state determination information for determining a power supply state of a local terminal;
by a power supply state determination information communication unit, performing communication for exchanging the power supply state determination information with another terminal;
by a representative terminal determination unit, determining a representative terminal on a basis of the power state determination information of the local terminal and the another terminal;
by a reference signal reception unit, receiving a reference signal necessary for synchronization and generating time information in a case where the local terminal corresponds to the representative terminal; and
by a time information communication unit, transmitting the time information to the another terminal in the case where the local terminal corresponds to the representative terminal, and receiving the time information from the representative terminal in a case where the local terminal does not correspond to the representative terminal.
